(19) United States
(12) Patent Application Publication
(10) Pub. No.: US 2018/0079457 A1
(43) Pub. Date: Mar. 22, 2018

(54) SPARE TIRE PRESENTATION DEVICE AND METHOD

(71) Applicant: FORD GLOBAL TECHNOLOGIES, LLC, Dearborn, MI (US)

(72) Inventors: Dean M. Jaradi, Macomb, MI (US); S.M. Iskander Farooq, Novi, MI (US); Mohammed Omar Faruque, Ann Arbor, MI (US); Scott Holmes Dunham, Redford, MI (US)

(21) Appl. No.: 15/270,633

(22) Filed: Sep. 20, 2016

(51) Int. Cl. B62D 43/10

(52) U.S. Cl. CPC B62D 43/10; B62D 25/087

(57) ABSTRACT

A spare tire presentation device includes a guide, a carriage displaceable along the guide and a spare tire support on the carriage. The spare tire support is displaceable between a first position and a second position. A related method of accessing a spare tire is also disclosed.

### TECHNICAL FIELD

This document relates generally to the motor vehicle equipment field and, more particularly, to a spare tire presentation device that allows one to more easily access and utilize a spare tire. A related method is also provided.

### BACKGROUND

When one is operating a car, one may incur a flat tire at virtually any time. The condition of the tire, the condition of the roadway and the presence of road debris including sharp objects such as glass, or the like may contribute to the unfortunate event.

In the event one incurs a flat tire, it may be necessary to access the spare tire of the motor vehicle and exchange it for the flat tire. Spare tires are typically stored in difficult to access locations such as in a spare tire storage well in the floor of a trunk underneath the trunk or deck lid carpet. The substantial weight of a spare tire and wheel compounds the problem of removing the spare tire from any difficult to reach location.

This document relates to a new and improved spare tire presentation device that displaces the spare tire from its storage position to a far more easily accessed position that is more ergonomically friendly for one facing the task of changing a flat tire.

### SUMMARY

In accordance with the purposes and benefits described herein, a spare tire presentation device is provided. That spare tire presentation device comprises a guide, a carriage displaceable along that guide and a spare tire support on the carriage. The spare tire support is displaceable between a first position and a second position.

The spare tire support may include a tire cradle and an actuator. The actuator may comprise a telescoping column having a first end connected to the carriage and a second end connected to the tire cradle.

The tire cradle may include a first leg having a first tire channel and a second leg having a second tire channel. Further, the spare tire cradle may also include a third leg having a third tire channel and a fourth leg. The fourth leg extends from the telescoping column toward a rear end of the motor vehicle to which the spare tire presentation device is anchored.

The guide may include a first guide track and a second guide track. The first guide track may comprise a first channel and the second guide track may comprise a second channel where the first channel is opposed to the second channel.

The carriage may include a first roller bearing assembly engaging the first channel and a second roller bearing assembly engaging the second channel. The first roller bearing assembly may include a first set of roller bearings engaging a first wall of the first channel and a second set of roller bearings engaging a second wall of the first channel. The second roller bearing assembly may include a third set of roller bearings engaging a third wall of the second channel and a fourth set of roller bearings engaging a fourth wall of the second channel.

In accordance with yet another aspect, a spare tire presentation device comprises a guide extending along a first axis and a carriage displaceable along the guide. The spare tire presentation device also includes a spare tire support on the carriage. The spare tire support is displaceable along a second axis substantially perpendicular to the first axis.

Still further, the first axis may be substantially parallel to an x-axis of the motor vehicle to which the spare tire presentation device is anchored. In contrast, the second axis may be substantially parallel to a z-axis of that motor vehicle.

In accordance with yet another aspect, a method is provided of accessing a spare tire from a spare tire storage well in a floor of a motor vehicle. That method comprises the steps of: (a) lifting the spare tire from the spare tire storage well by operation of an actuator held on a carriage and (b) sliding the carriage motor vehicle rearward along a guide fixed to the motor vehicle. Still further, the method may include the step of positioning at least a portion of the spare tire overlying a closure sill of the motor vehicle when the spare tire is fully deployed to the presentation position for easier access.

In the following description, there are shown and described several preferred embodiments of the spare tire presentation device. As it should be realized, the spare tire presentation device is capable of other, different embodiments and its several details are capable of modification in various, obvious aspects all without departing from the spare tire presentation device as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the spare tire presentation device and together with the description serve to explain certain principles thereof. In the drawing figures:

FIG. 1 is a perspective view of a motor vehicle illustrating the spare tire presentation device in the stowed position with the spare tire received and held in a spare tire storage well in the floor of the motor vehicle.

FIG. 2 is a more detailed perspective view illustrating the spare tire in a raised, intermediate position above the spare tire storage well.

FIG. 3 is a perspective view similar to FIG. 2 but illustrating the spare tire in the final, presentation position wherein a portion of the spare tire overlies the sill of the closure where the tire may be more easily accessed by the individual.

FIG. 4 is a detailed perspective view of the spare tire presentation device in the stowed position (the spare tire has been removed for clarity of presentation).

FIG. 5 is a schematic elevational view of the spare tire presentation device with the actuator of the spare tire support in the first or lowered position.

FIGS. 6a-6d are a series of detailed perspective views illustrating the operation of the spare tire presentation device when displacing the spare tire from the stowed position within the spare tire storage well as illustrated in FIG. 1 to the presentation position as illustrated in FIG. 3.

Reference will now be made in detail to the present preferred embodiments of the spare tire presentation device, an example which is illustrated in the accompanying drawing figures.

### DETAILED DESCRIPTION

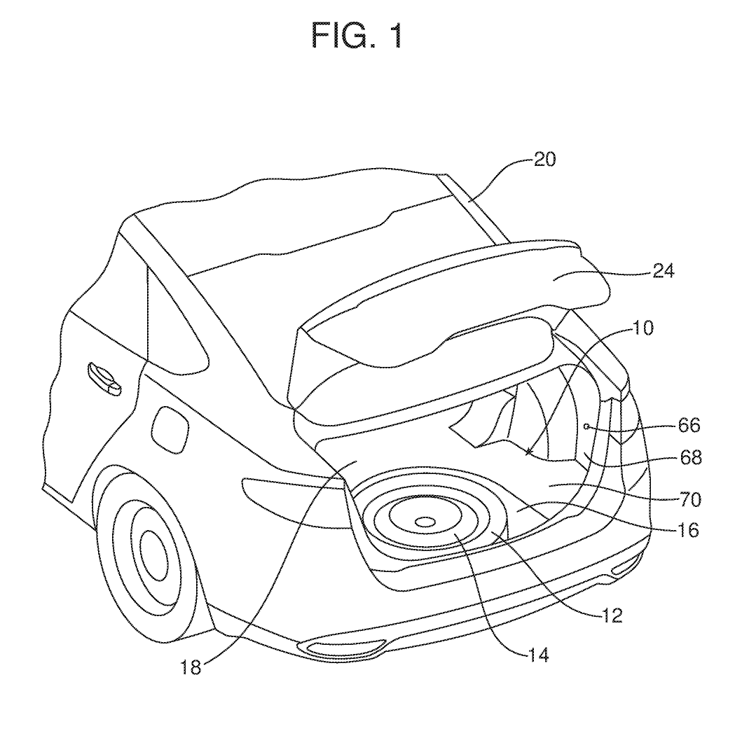

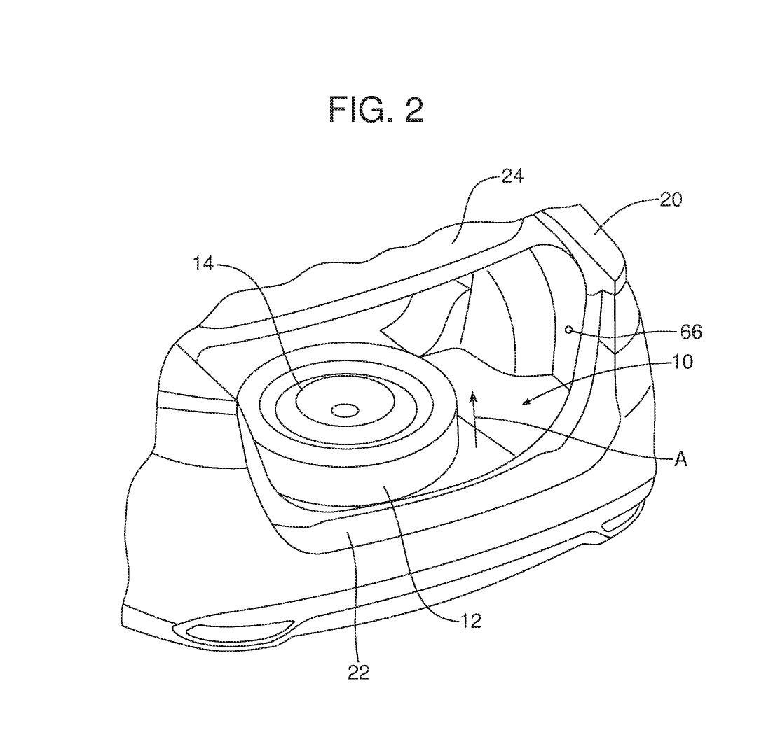

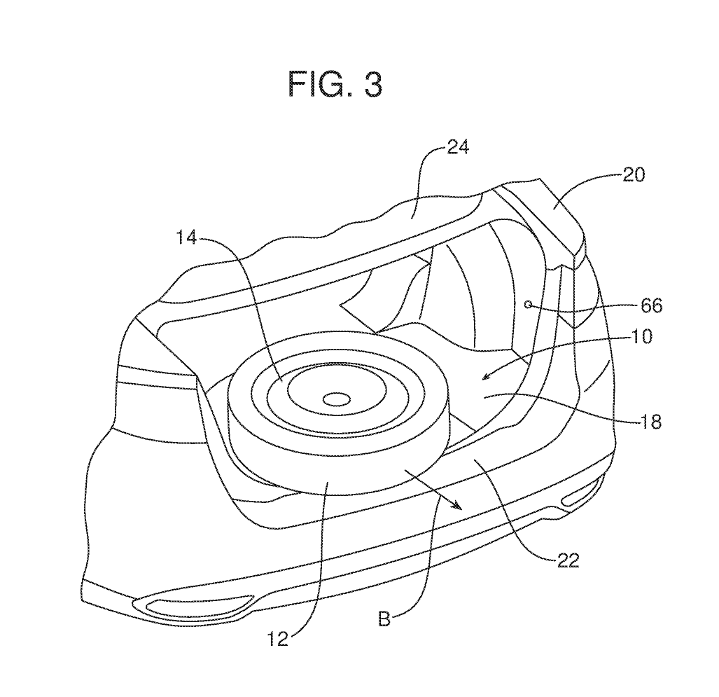

Reference is now made to FIGS. 1-3, which are a series of illustrations depicting the operation of the spare tire presentation device 10. That spare tire presentation device 10 allows one to displace a spare tire 12, as well as the wheel 14 to which the spare tire is attached, from a stowed position illustrated in FIG. 1, through an intermediate position illustrated in FIG. 2 to a final presentation position illustrated in FIG. 3.

More specifically, in the stowed position, the spare tire 12 and wheel 14 are maintained in a spare tire storage well 16 provided in the floor 18 of the motor vehicle 20. In the intermediate position illustrated in FIG. 2, the spare tire 12 and wheel 14 had been lifted from the spare tire storage well 16 (note action arrow A). In the presentation position illustrated in FIG. 3, the spare tire 12 and wheel 14 had been displaced motor vehicle rearward (note action arrow B) so that a portion of the spare tire 12 overlies the sill 22 for the closure 24, which in the illustrated embodiment comprises a trunk lid. One may more easily access and manipulate the spare tire 12 and wheel 14 from the presentation position.

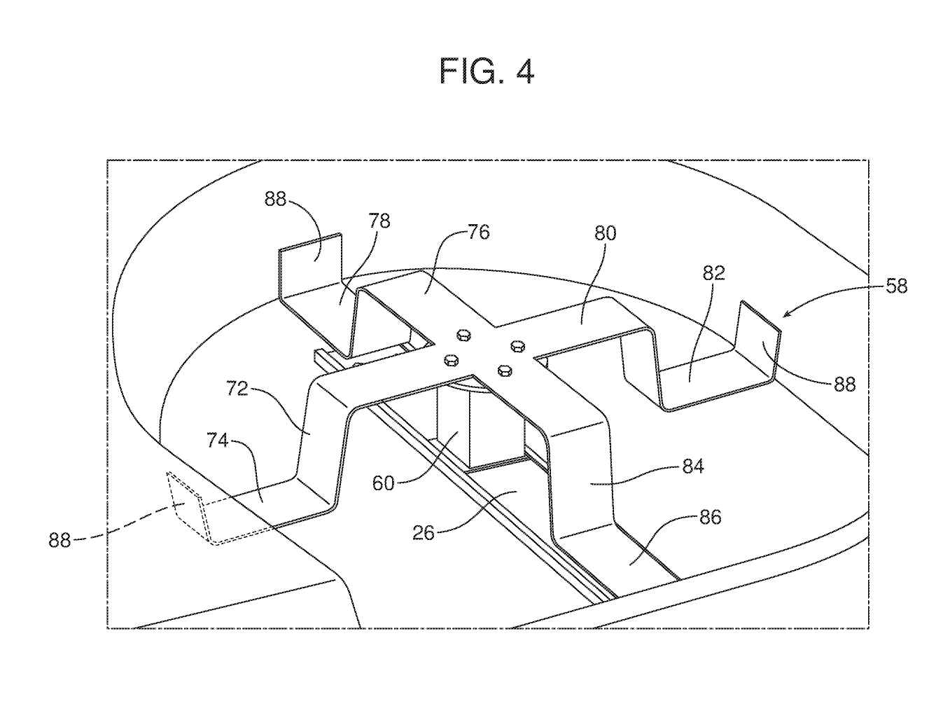

Reference is now made to FIGS. 4-6d illustrating the spare tire presentation device 10 in detail. As shown, the spare tire presentation device 10 includes a guide 26. In the illustrated embodiment, the guide 26 includes a first guide track 28 and a second guide track 30. The first guide track 28 comprises a first channel while the second guide track 30 comprises a second channel where the first channel is opposed to the second channel. Fasteners 32 fix the guide 26 to the floor 18 of the motor vehicle 20.

The spare tire presentation device 10 also includes a carriage 34. As will become apparent from the following description, the carriage 34 is displaceable along the guide 26 along a first axis A1 which substantially corresponds to or is substantially parallel to the x-axis of the motor vehicle 20.

More specifically, the carriage 34 includes a first roller bearing assembly 36 engaging the first channel or guide track 28 and a second roller bearing assembly 38 engaging the second channel or guide track 30.

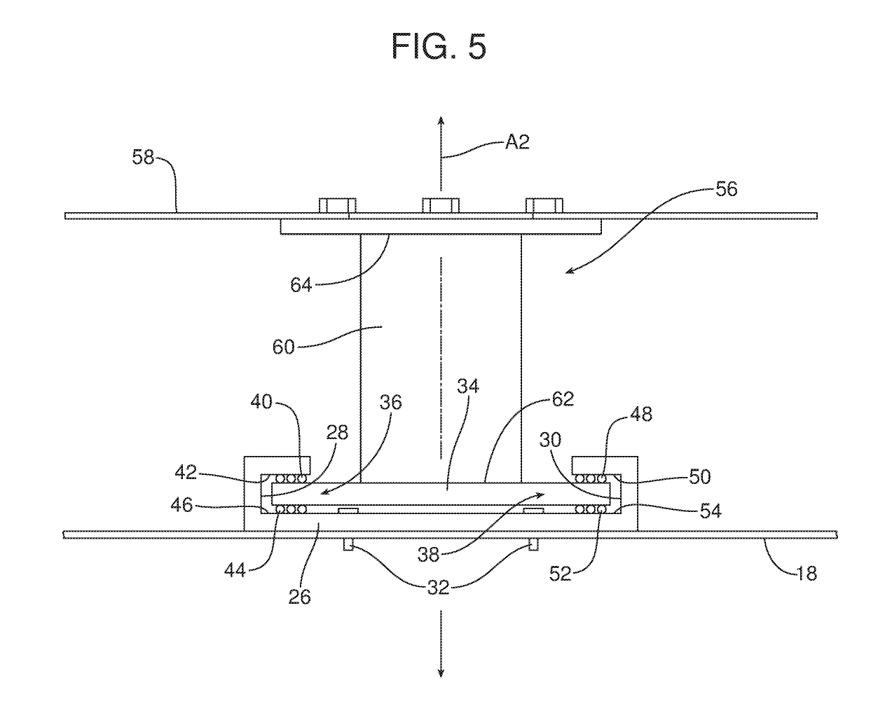

More specifically, as best illustrated in FIG. 5, the first roller bearing assembly 36 includes a first set of roller bearings 40 that engage a first wall 42 of the first channel or guide track 28 and a second set of roller bearings 44 that engage a second wall 46 of the first channel or guide track 28.

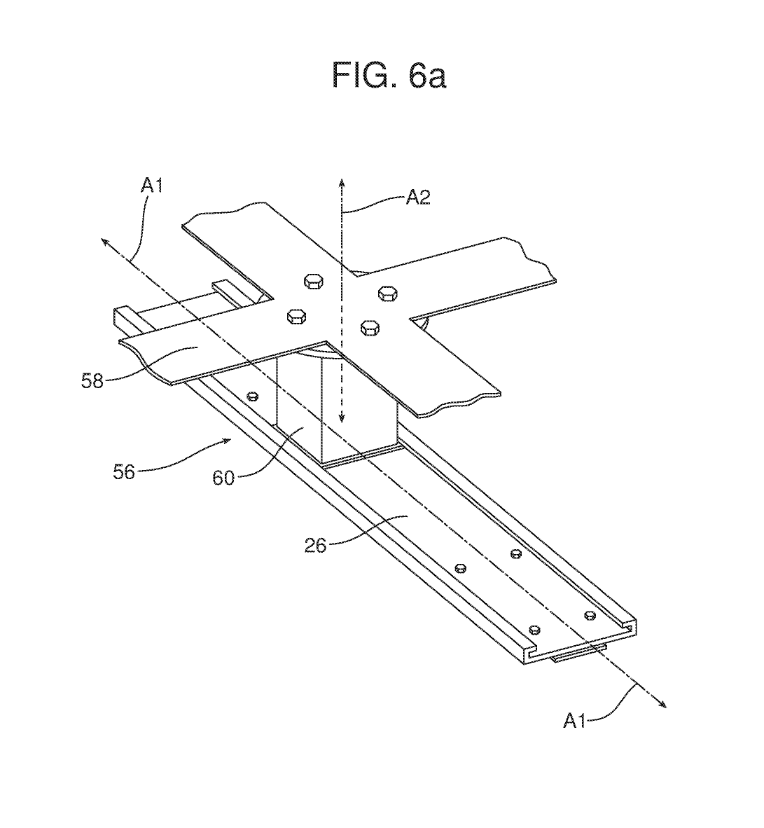

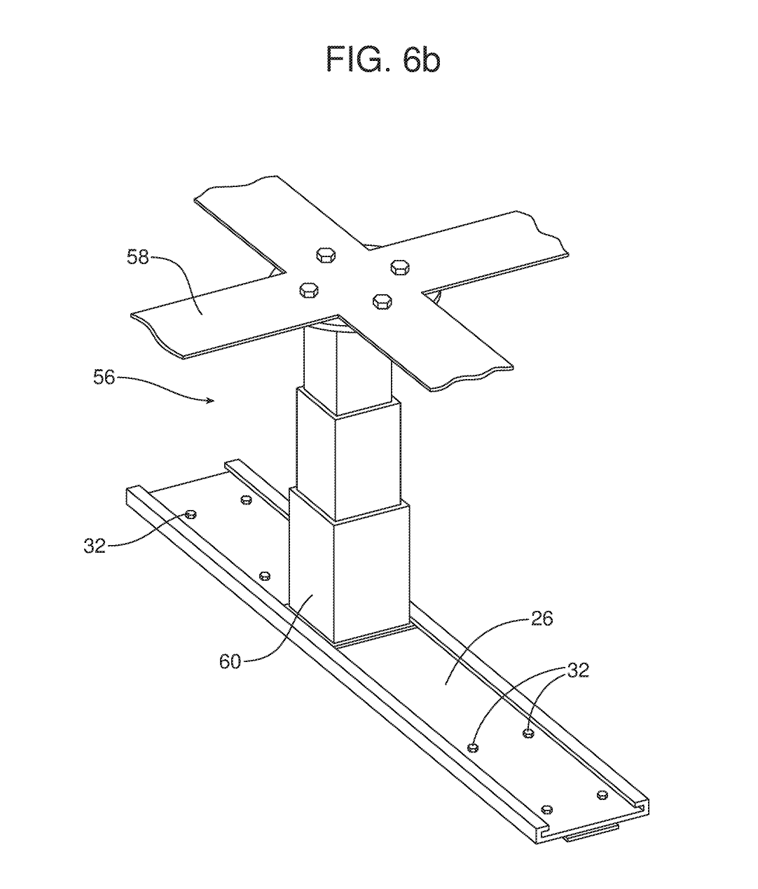

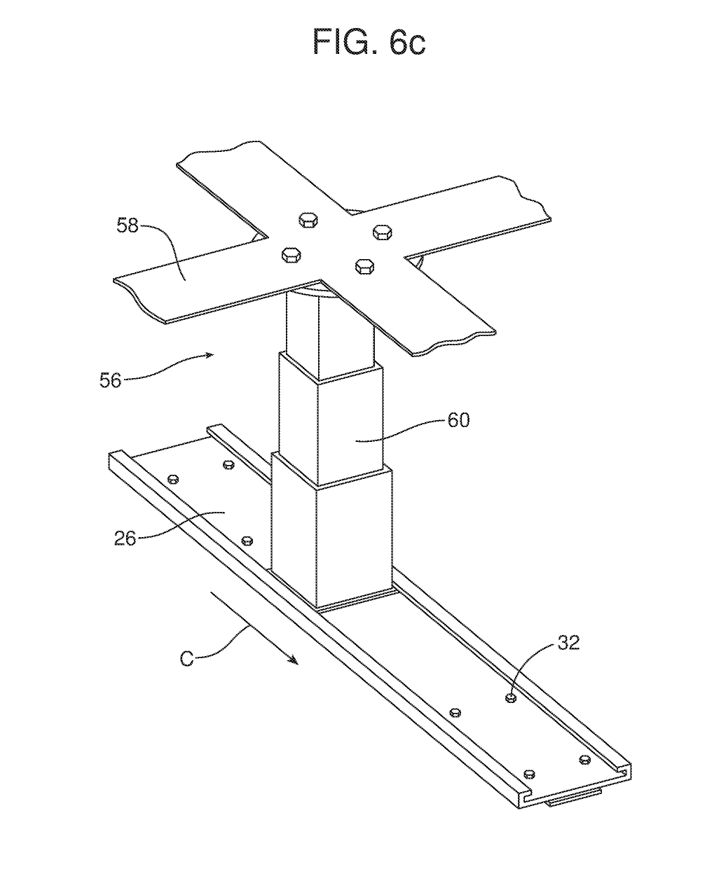

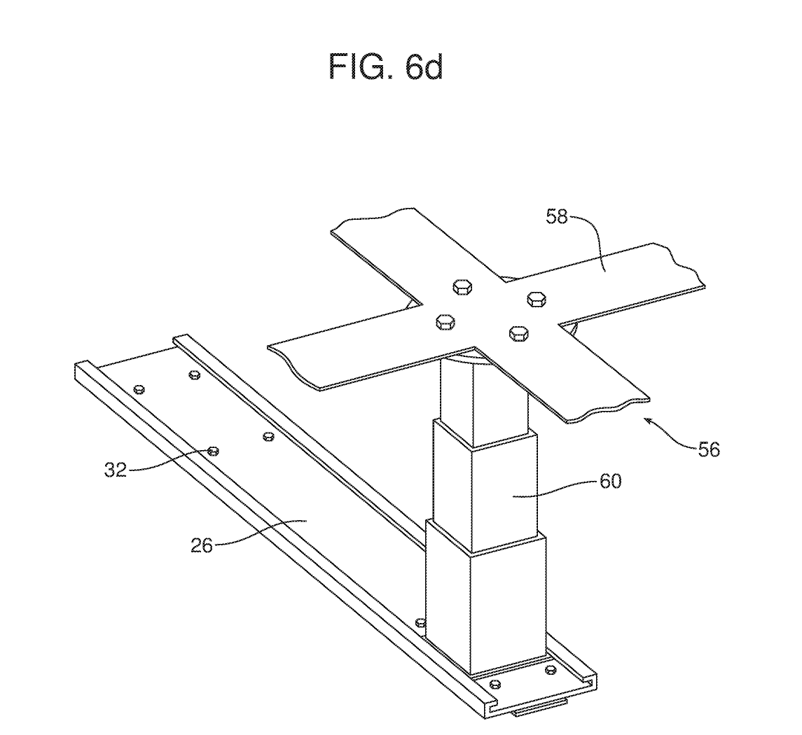

The second roller bearing assembly 38 includes a third set of roller bearings 48 engaging a third wall 50 of the second channel or guide track 30 and a fourth set of roller bearings 52 engaging a fourth wall 54 of the second channel or second guide track 30. As should be appreciated, the first roller bearing assembly 36 and the second roller bearing assembly 38 provide for free sliding movement of the carriage 34 along the guide 26 from a first or motor vehicle forward position illustrated in FIGS. 1 and 6a and a second or motor vehicle rearward position illustrated in FIGS. 3 and 6d. Cooperating detents (not shown) may be provided in the guide 26 to receive the first and second roller bearing assemblies 36, 38 and help hold the carriage 34 in the first position and the second position if desired.

The spare tire presentation device 10 also includes a spare tire support, generally designated by reference numeral 56. See FIGS. 4 and 5. In the illustrated embodiment, the spare tire support 56 includes a tire cradle 58 and an actuator 60. In the illustrated embodiment, the actuator 60 comprises a telescoping column having a first end 62 connected to the carriage 34 and a second end 64 connected to the tire support frame 58.

In the illustrated embodiment, the telescoping column or actuator 60 is an electric jack that may be activated by operation of a push button 66 provided on the wall 68 of the motor vehicle trunk 70 when one depresses the push button 66, the telescoping column/actuator 60 is activated and the spare tire 12 and wheel 14 is lifted from the spare tire storage well 16 (that is: the spare tire 12 and wheel 14 are displaced from the stowed position illustrated in FIG. 1 to the immediate deployed position illustrated in FIG. 2—see also FIGS. 6a and 6b showing the operation of the telescoping columns/actuator).

Following the lifting of the spare tire 12 and wheel 14 from the spare tire storage well 16, the carriage 34 is displaced from the first or most forward position illustrated in FIGS. 2 and 6a to the second or most rearward position illustrated in FIGS. 3 and 6d. More specifically, one engages the spare tire 12 with one or both hands and pulls motor vehicle rearward. This causes the carriage 34 that supports the spare tire 12 and wheel 14 to slide smoothly along the guide 26 in the direction of action arrow C until a portion of the spare tire 12 overlies the sill 22 of the closure 24. See FIG. 3. As a result, one may more easily access the spare tire 12 and wheel for changing a flat tire or other purposes in an ergonomically friendly fashion.

Reference is now made back to FIG. 4 illustrating the structure of the tire cradle 58. As illustrated, the tire cradle 58 includes a first leg 72 having a first tire channel 74 and a second leg 76 having a second tire channel 78. The spare tire support frame 58 also includes a third leg 80 having a third tire channel 82 and a fourth leg 84 having a tire shelf 86 rather than a tire channel. Here it should be appreciated that the first tire channel 74, second tire channel 78 and third tire channel 82 all include respective upwardly directed flanges 88 at the distal end of the respective first leg 72, second leg 76 and third leg 80. In contrast, the fourth leg 84 does not include such a flange. As should be appreciated, the fourth leg 84 extends from the telescoping column/actuator 60 toward a rear end of the motor vehicle 20 along the first axis A1 which corresponds to the x-axis of the motor vehicle 20. The three channel structure 74, 78, 82 securely holds the spare tire 12 and wheel 14 in position while the simple rearwardly-directed shelf simultaneously allows one to easily remove the spare tire and wheel for use once the spare tire presentation device 10 is in the final presentation position illustrated in FIG. 3.

Consistent with the above, a method is provided for more easily accessing a spare tire 12 from a spare tire storage well 16 in a floor 18 of a motor vehicle 20. That method comprises the step of lifting the spare tire 12 from the spare tire storage well 16 by operation of a telescoping column/actuator 60 held on a carriage 34. This lifting is along a second axis A2 that extends along or substantially parallel to the z-axis of the motor vehicle 20. Next, the method includes the step of sliding the carriage 34 motor vehicle rearward along the guide 26 that is fixed to the motor vehicle 20 and extends along a first axis A1 that corresponds to or is substantially parallel to the x-axis of the motor vehicle 20. Further, the method includes the step of positioning at least a portion of the spare tire 12 overlying the sill 22 of the closure 24 of the motor vehicle 20 as illustrated in FIG. 3.

The foregoing has been presented for purposes of illustration and description. It is not intended to be exhaustive or to limit the embodiments to the precise form disclosed. Obvious modifications and variations are possible in light of the above teachings. For example, the guide 26 illustrated in the drawing figures comprises a single piece body including the first guide track 28 and the second guide track 30. It should be appreciated that the guide 26 may comprise two separate or individual guide tracks if desired. All such modifications and variations are within the scope of the appended claims when interpreted in accordance with the breadth to which they are fairly, legally and equitably entitled.

What is claimed:

1. A spare tire presentation device, comprising:
a guide;
a carriage displaced along said guide; and
a spare tire support on said carriage, said spare tire support being displaceable between a first position and a second position.

2. The spare tire presentation device of claim 1, wherein said spare tire support includes a tire cradle.

3. The spare tire presentation device of claim 2, wherein said spare tire support includes an actuator.

4. The spare tire presentation device of claim 3, wherein said actuator is a telescoping column having a first end connected to said carriage and a second end connected to said tire cradle.

5. The spare tire presentation device of claim 4, wherein said guide includes a first guide track and a second guide track.

6. The spare tire presentation device of claim 5, wherein said first guide track is a first channel and said second guide track is a second channel, said first channel being opposed to said second channel.

7. The spare tire presentation device of claim 6, wherein said carriage includes a first roller bearing assembly engaging said first channel and a second roller bearing assembly engaging said second channel.

8. The spare tire presentation device of claim 7, wherein said first roller bearing assembly includes a first set of roller bearings engaging a first wall of said first channel and a second set of roller bearings engaging a second wall of said first channel.

9. The spare tire presentation device of claim 8, wherein said second roller bearing assembly includes a third set of roller bearings engaging a third wall of said second channel and a fourth set of roller bearings engaging a fourth wall of said second channel.

10. The spare tire presentation device of claim 9, wherein said tire cradle includes a first leg having a first tire channel and a second leg having a second tire channel.

11. The spare tire presentation device of claim 10, wherein said tire cradle includes a third leg having a third tire channel and a fourth leg.

12. The spare tire presentation device of claim 11, wherein said fourth leg extends from said telescoping column toward a rear end of a motor vehicle to which said spare tire presentation device is anchored.

13. The spare tire presentation device of claim 1, wherein said spare tire support includes an actuator and said actuator is a telescoping column having a first end connected to said carriage.

14. The spare tire presentation device of claim 13, wherein said guide includes a first guide track and a second guide track.

15. The spare tire presentation device of claim 14, wherein said first guide track is a first channel and said second guide track is a second channel where said first channel is opposed to said second channel.

16. The spare tire presentation device of claim 15, wherein said carriage includes a first roller bearing assembly engaging said first channel and a second roller bearing assembly engaging said second channel.

17. A spare tire presentation device, comprising:
a guide extending along a first axis;
a carriage displaceable along said guide; and
a spare tire support on said carriage, said spare tire support being displaceable along a second axis substantially perpendicular to said first axis.

18. The spare tire presentation device of claim 17, wherein said first axis is substantially parallel to an x-axis of a motor vehicle to which said spare tire presentation device is anchored and said second axis is substantially parallel to a z-axis of said motor vehicle.

19. A method of accessing a spare tire from a spare tire storage well in a floor of a motor vehicle, comprising:
lifting said spare tire from said spare tire storage well by operation of an actuator held on a carriage; and
sliding said carriage motor vehicle rearward along a guide fixed to said motor vehicle.

20. The method of claim 19, further including positioning at least a portion of said spare tire overlying a closure sill of said motor vehicle.
